(19) United States
(12) Patent Application Publication
(10) Pub. No.: US 2023/0022827 A1
(43) Pub. Date: Jan. 26, 2023

(54) Direct Printing and Printer

(71) Applicant: Hewlett-Packard Development Company, L.P., Spring, TX (US)

(72) Inventors: Bartomeu Gaya Pol, Sant Cugat del Valles (ES); Alexandre Rodriguez Llofriu, Sant Cugat del Valles (ES); Alejandro Alarcon Cano, Sant Cugat del Valles (ES)

(21) Appl. No.: 17/381,907

(22) Filed: Jul. 21, 2021

(51) Int. Cl. B41J 11/46; B41J 11/00; B41J 3/36; B41J 3/407; B41J 19/20; B41J 29/38

(52) U.S. Cl. CPC B41J 11/46; B41J 3/36; B41J 3/4073; B41J 11/008; B41J 11/0095; B41J 19/205; B41J 29/38

(57) ABSTRACT

A printer for direct printing on a print substrate comprises a front support supporting a printing device; the front support to be arranged at a front side of a print substrate and to be aligned relative to a rear support across the print substrate in a contact-less manner.

### BACKGROUND

For providing a large or bulky object with a printed image, the image may be printed on a flat print media and may be transferred or attached to the object. Alternatively, an image may be printed directly on the object but direct printing on a substrate which is too large or bulky to be fed through a printer has its own challenges.

### SHORT DESCRIPTION OF DRAWINGS

The following detailed description will best be understood with reference to the drawings, wherein:

FIG. 1 schematically shows a substrate which is being printed on directly by a printer, according to an example;

FIG. 2 shows a schematic perspective diagram of a printer according to an example, from a front side thereof;

FIG. 3 shows a schematic perspective diagram of the printer according to an example, from a rear side thereof;

FIG. 4 shows a schematic plan view of the printer according to an example, from the front side;

FIG. 5 shows a schematic side view of the printer according to an example;

FIG. 6 shows a schematic plan view of the printer according to an example, from the rear side;

FIG. 7 shows a schematic plan view of a front part of the printer according to an example, from a rear side thereof;

FIG. 8 shows a schematic perspective diagram of the front part of the printer according to an example, from the rear side;

FIG. 9 shows a schematic plan view of a rear part of the printer according to an example, from a front side thereof;

FIG. 10 shows a schematic perspective diagram of the rear part of the printer according to an example, from the front side; and

FIG. 11 shows a flow diagram of a printing method according to an example.

### DESCRIPTION OF EXAMPLES

The following disclosure provides different examples, for implementing different features of the disclosed subject matter. Specific examples of components, values, operations, materials, arrangements, or the like, are described below to simplify the present disclosure. Other components, values, operations, materials, arrangements, or the like, are contemplated. In addition, the present disclosure may repeat reference numerals and/or letters in the various examples. This repetition is for the purpose of simplicity and clarity, respective components designated by the same reference numerals may be implemented and may operate in an identical or similar way, without being bound to this.

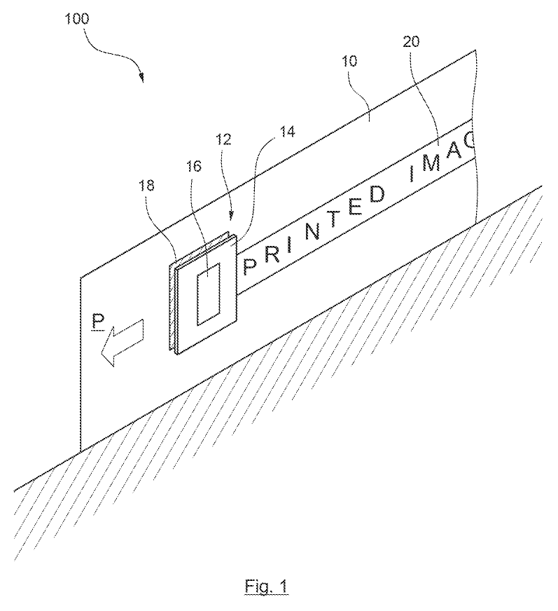

FIG. 1 schematically illustrates an example of a printer 100 to directly print on a print substrate 10, according to an example. In FIG. 1, the print substrate 10 is a plate or pane, e.g. a glass pane or an acrylic pane, such as plexiglass, which is mounted in a vertical orientation. The print substrate 10, for example, may be a window pane, separation wall or another thin wall or pane defining a space, and/or an advertisement surface, for example. The print substrate also may be a thin wood panel, a canvas, a non-ferromagnetic metal plate, a plaster-board, such as sheetrock, or another plate-like substrate. The print substrate, in general, may have a laminar shape, which is relatively thin in one direction, e.g. having a thickness in the order of less than a millimeter to a ten or more millimeters, e.g. 0.1 to 30 mm or 1 to 20 mm. For example, the printer may be designed to work for print substrates up to 20 mm thickness, with a tolerance of 30%. The print substrate further may have relatively large extensions in the width and length direction or height and length direction, perpendicular to its thickness. Each of the width and length or height and length may be larger than 0.5 m, or larger than 1 m, for example. In its mounted position, the print substrate may present a vertical printing surface or another non-horizontal printing surface but also may be aligned horizontally. Depending on the orientation of the print substrate, the printer design may be adapted, as explained below.

It may be desirable to provide a printed image on the print substrate 10, without removing the print substrate 10 from its mounting position. It further may be desirable to provide the printed image without using an intermediate carrier, such as adhesive print media, to print remotely and attach the image to the print substrate 10.

In the example of FIG. 1, a printer 100 is provided for directly printing on the print substrate 10, the printer 100 comprising a front support 14 supporting a printing device 16, and a rear support 18. The front support 14 is to be arranged at front side of the print substrate 10 and is to be aligned relative to the rear support 18 across the print substrate 10 in a contactless manner. Alignment of the front support 14 and the rear support 18 may be implemented without the front support 14 and the rear support 18 being in direct physical contact. With the front support 14 and the rear support 18 being aligned, the printing device 16 carried by the front support 14 may be guided across the front surface of the print substrate 10 to print an image 20.

In the context of this disclosure, if reference is made to a front part or a front side or front surface or a rear part or a rear side or rear surface of a component, this refers to a respective orientation, side or surface relative to the print substrate as seen by a viewer looking at a surface of the print substrate which is to receive the printed image. More generally, where the spatial relationship of individual parts of the printer is described in the following, this spatial relationship refers to an operating position of the printer as seen when looking at the image receiving side of the print substrate. Accordingly, the front side or surface of the print substrate is the side being printed on and the rear side or surface of the print substrate is the opposite side thereof.

In one example, the printing device 16 schematically shown in FIG. 1, may comprise components for printing, such as a printing fluid supply, printing fluid pump, printhead pocket or mount, printhead and controller. The printhead may be a replaceable component. In one example, the printing device 16 may use inkjet technology, printing with e.g. latex inks. In one example, described in further detail below, the front support 14 and the rear support 18 may be engaged and aligned via magnets, with the print substrate 10 there between. Magnetic coupling is without direct contact between the front support 14 and the rear support 18 so that the front support 14 and the rear support 18 can be arranged on two sides of the print substrate 10 having large dimensions in two directions, such as a window pane or thin separation wall, for example. Magnetic coupling aligns the front support 14 and the rear support 18 and positions the supports 14, 18 relative to the print substrate 10. This also allows printing on a vertical surface or another non-horizontal surface, e.g. an inclined surface of the print substrate 10, with the printer maintaining its intended position, as explained in further detail below.

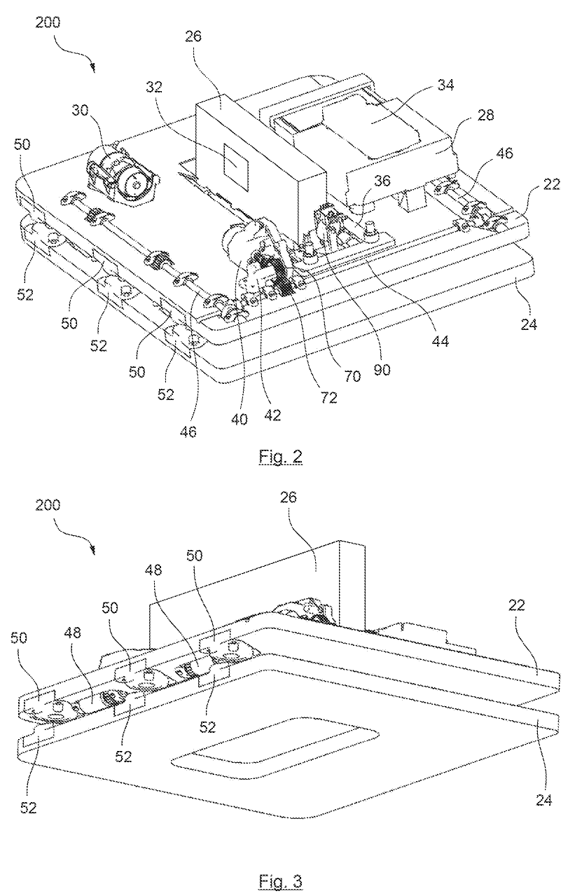

A more detailed example of a printer 200 is described with reference to FIGS. 2 to 10. In this and other examples, the printer 200 may comprise a front platform 22, which is an example of a front support or printing platform, and the rear platform 24, which is an example of rear support or counter platform. The front platform 22, on a front side thereof, may carry components of the printing device, such as a printhead 26, a printing fluid reservoir 28, a printing fluid pump 30, one or more controllers 32, 34 which may be associated with the printhead 26 and/or the printing fluid reservoir 28. The printhead 26 may be received in a printhead pocket or printhead mount 36. Both controllers 32, 34 may include or be associated with respective memories. The printhead controller 82 may store an image to be printed and may store or generate respective print commands for controlling ejection of print fluid from the printhead 26.

In this and other examples, the front platform 22 may carry, on its front side, a motor 40 having an output shaft coupled to a gearbox 42. The gearbox is an example of a transmission gear. The motor may be an electric DC motor, e.g. a brushless or brush motor. A controller (not shown) may be associated with the motor 40 wherein the motor controller may be in communication with the printhead controller 32, for example. Communication can be wired or wireless.

The gearbox 42 may be a reduction gearbox. An output of the gearbox 42 may be coupled to a first transmission shaft 44, via a tooth gear on the first transmission shaft 44, for example. The first transmission shaft 44 may be coupled to a pair of second transmission shafts 46 extending along opposite edges of the front platform 22. Rotation of the output shaft of the motor 40 may be transferred to the pair of second transmission shafts 46 via the first transmission shaft 44 and the gearbox 42. The pair of second transmission shafts 46 may be coupled to a plurality of rollers 48 arranged at the rear side of the front platform 22 along the edges thereof. Coupling may be via a pair of tooth gears between the respective second transmission shaft 46 and each roller 48. The rollers 48 may be driven to rotate by the pair of second transmission shafts 46. The gearbox or the gearbox in combination with the transmission shaft (s) may provide a self-locking transmission to transmit rotation of the motor to the rollers 48 when driven and block rotation of the rollers 48 when not driven by the motor 40. The rollers 48 on the front platform 22 may be designated as active or driven rollers.

Electric and electronic components of the printing device and motors may be powered from a battery or via a mains connection.

The front platform 22 in this and other examples, at its rear side, further may carry a number of front magnets 50 facing the front side of the rear platform 24. The rear platform 24 in this and other examples, at its front side, may further carry number of corresponding rear magnets 52. Magnetic coupling between the front magnets 50 and the rear magnets 52 may align the front platform 22 and the rear platform 24 relative to each other and position the platforms 22, 24 relative to a print substrate. The front platform 22 also may be considered a printing platform. The rear platform 24 also may be considered a counter platform, from a perspective of the front platform 22. Similarly, the magnets 52 of the rear platform 24 may be considered counter magnets, from a perspective of the magnets 50 of the front platform 22. The magnets 50, 52 are oriented relative to each other in a way so as to generate an attracting force.

The magnets 50, 52 may be permanent magnets, e.g. neodymium magnets, and may be selected and designed to generate an attraction force which is able to hold the printer 200 in position on a vertical or non-horizontal print substrate and to allow movement of the printer 200 along the surface of the print substrate.

In this or other examples, the rear platform 24 may carry, on its front side, a plurality of rollers 54 arranged at the front side of the rear platform 24 along the opposite edges thereof. The rollers 54 on the rear platform 24 may be designated as passive or non-driven rollers. The rollers 48 on the front platform 22 and the rollers 54 on the rear platform 24, when the two platforms are aligned, may be arranged opposite to each other across the print medium. Instead of rollers 54, the rear platform may be provided with sliders or rotatable balls to provide a low friction engagement between the front side of the rear platform 24 and the print substrate rear surface. The rollers 48 on the front platform 22 or the respective opposite rollers 48, 54 on the front and rear platforms 22, 24 may be provided to enable movement of the printer 200 relative to the print substrate. The rollers also may improve parallelism of movement of the printing device with respect to the print substrate when moving in a printing direction. When the rollers 48 of the front platform 22 are driven by the motor 40, via the gearbox 42 and the transmission shafts 44, 46, the platforms can be moved relative to the print substrate wherein the magnets 50, 52 may hold the platforms in a desired position relative to the print substrate.

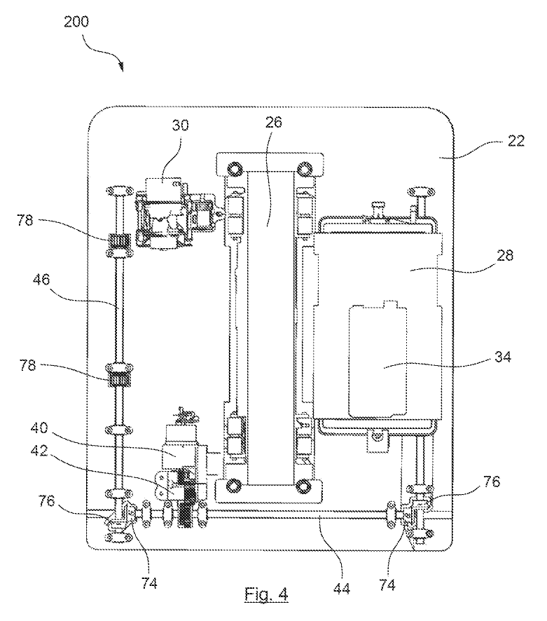

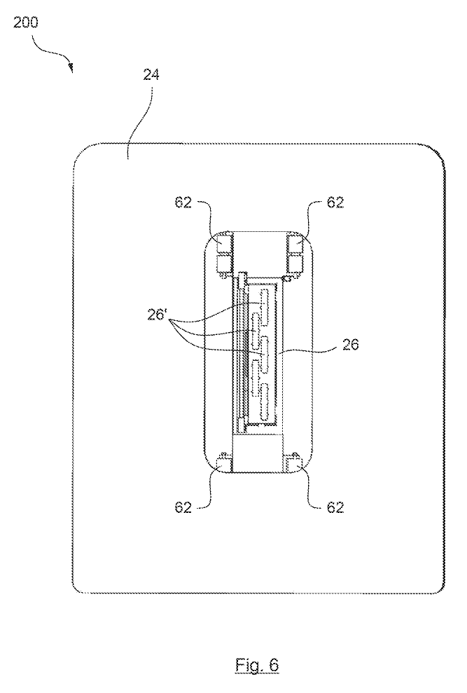

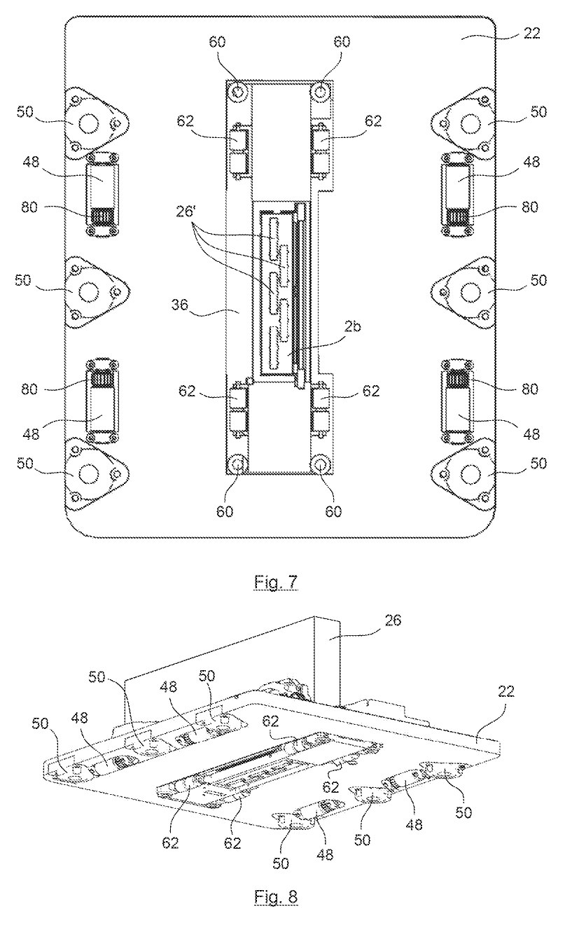

As illustrated in FIGS. 2 and 4, components of the printing device include, in this example, the printhead 26, the printing fluid reservoir 28, the fluid pump 30, and two controllers 32, 34 which are associated with the printhead 26 and the printing fluid reservoir 28, respectively. The printhead 26 is received in the printhead pocket or printhead mount 36. The printhead 26 may be an inkjet type printhead to dispense printing fluid, such as ink, for example latex ink, on the print substrate. The fluid pump 30 may be coupled with the printing fluid reservoir 28 and the printhead 26 to feed the printing fluid from the printing fluid reservoir 28 to the printhead 26. As illustrated in FIGS. 6 and 7, the printhead 26 may comprise a number of printheads dies to eject one or multiple printing fluids. The printing fluid may contain pigment particles and additional particles, such as a polymer component. Each of the pigment particles may carry a color, for example, cyan, magenta, yellow, or key (black) or white.

The print fluid disposed on the surface of the print substrate further may be processed such as to support the adhesion of the pigment particles to the surface of the print substrate. The additional particles may support the adhesion of the pigment particles to the surface of the print substrate. For example, the additional particles in the printing fluid may be polymerizable such as to form chain-like structures. For example, the additional particles in the print fluid are to coalesce under heat. For example, the additional particles may comprise latex-like or latex-based contents. Such a print fluid may be referred to as a Latex ink. For curing the ink, heating resistors may be provided at the rear side of the front platform 22, for example.

The printhead 26 may include printhead dies 26' to eject one or two colors, such as black and white, or a selection of one or more of cyan, magenta, yellow, or a mixed color, for example. Each printhead die 26' may include one, two or more columns of fluid injection nozzles, each color for one color, for example. To print images of multiple colors, it is possible to arrange a number of printheads 26 on the front platform 22, side-by-side, for example. In this case, the printhead pocket or printhead mount 36 may be adapted accordingly.

The printhead pocket or printhead mount 36, this example, may be or may comprise a cut out in the front platform 22, as best illustrated in FIGS. 7 and 8. The printhead 26 may be suspended in the cut out 36 via springs 60 which may be located at four corners of the cut out 56, as illustrated in FIG. 7. Additionally, the printhead 26 may be provided with printhead rollers 62 which may support the printhead 26 against the front surface of the print substrate. The springs 60 may provide a resilient bias of the printhead 26, in the direction of the print substrate, which allows a limited movement of the printhead perpendicular to the front platform 22 and, during operation of the printer 200, perpendicular to the front surface of the print substrate. The springs 60 may apply a force to the printhead 26 in a direction towards the print substrate, and the printhead rollers 62 may protrude from the die carrying surface of the printhead 26 to avoid direct contact between the printhead dies 26' and the print substrate. This enables maintaining a constant spacing between the printhead dies 26' and the front surface of the print substrate to account for irregularities in the substrate surface and curved or otherwise non-plane substrate surfaces.

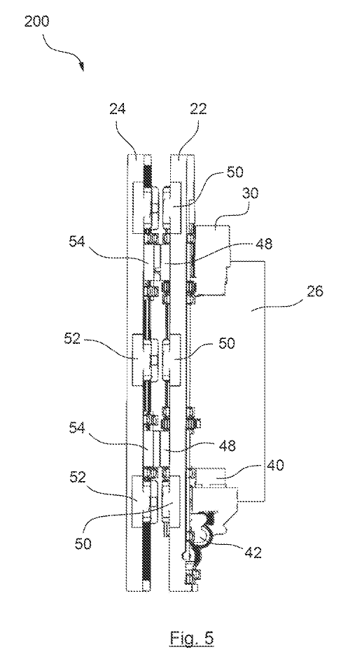

As best seen in FIGS. 5, 8, and 10, the magnets 50, 52 and the rollers 48, 54 on the front platform 22 and the rear platform 24 respectively protrude from the respective rear and front surfaces of the front and rear platforms 22, 24. The rollers 48 may extend from the front platform rear surface at a first height, and the magnets 50 may extend from the front platform rear surface at a second height, with the first height being larger than the second height. Similarly, the rollers 54 may extend from the rear platform front surface at a third height, and the magnets 52 may extend from the rear platform front surface at a fourth height, with the third height being larger than the fourth height. In other words, the rollers 48, 54 may extend from the respective platform surfaces by a larger distance than the magnets 50, 52. As a result, when the front platform 22 and the rear platform 24 are arranged on the two opposite sides of a print substrate and are aligned relative to each other by the attraction force of the magnets 50, 52, the rollers 48, 54 may be in contact with the substrate surface and the magnets 50, 52 may be spaced from the substrate surface. This allows the front and rear platforms 22, 24 to be moved along the width or length of the print substrate by low friction contact between the rollers 48, 54 with the substrate surface and without contact and friction between the magnets 50, 52 and the print substrate surface.

The difference in height between the magnets 50, 52 and the rollers 48, 54 from the respective surfaces of the first and second platforms 22, 24, i.e. the difference in height between the first height and the second height or the difference between the third height the fourth height may be in range of about 0.5 to 5 mm, or 0.5 to 3 mm, more specifically about 1 to 2 mm, for example. As previously indicated, instead of rollers 54, other low friction elements, such as sliders coated with low friction surface material, such as a silicone-containing material, may be provided at the front side of the rear platform 24.

As best illustrated in FIGS. 2, 4, and 7, rotation of the motor 40 may be transmitted to the rollers 48 via (i) a pair of tooth gears 70, 72 which may comprise an output gear 70 of the gearbox 42 and a drive gear 72 of the first transmission shaft 44; (ii) respective pairs of tooth gears 74, 76 which may comprise respective output gears 74 of the first transmission shaft 44 and drive gears 76 of the second transmission shafts 46; and (iii) respective pairs of tooth gears 78, 80 which may comprise respective output gears 78 of the second transmission shafts 46 and drive gears 80 of the driven rollers 48. Instead of tooth gears, other transmission components may be used.

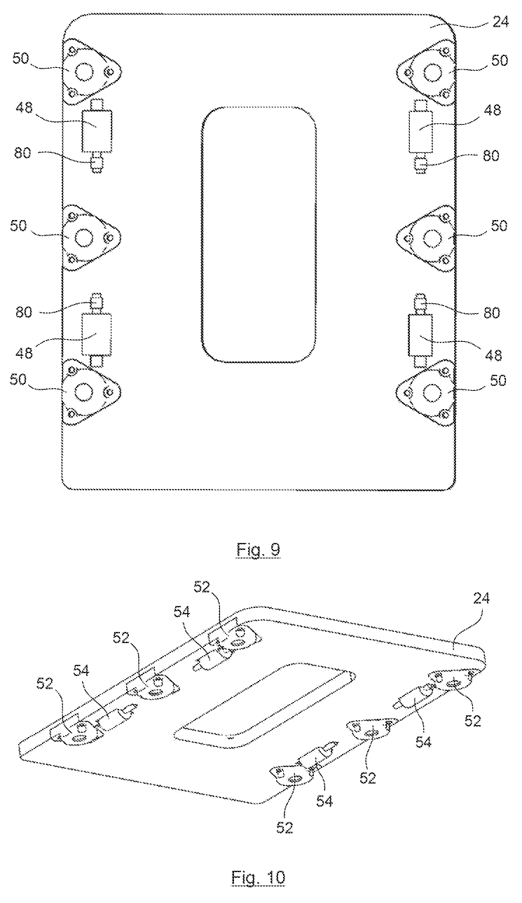

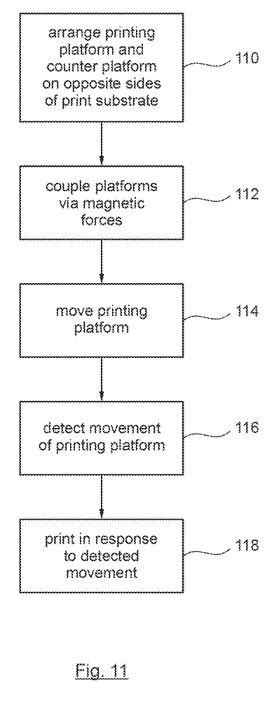

As explained above and as best illustrated in FIGS. 9 and 10, non-driven rollers 54 may be arranged at the front side of the rear support 24, opposite to the driven rollers 48 on the rear side of the front support 22. In this example, each roller 48, 54 is arranged between two neighboring magnets 50, 54 to generate an evenly distributed normal force between the rollers 48, 58 and the front and rear surfaces of the print substrate. As illustrated in FIGS. 7 and 9, the rollers 48, 54 are arranged along two opposite edges of the facing sides of the front and rear platform 22, 24 and extend along the length of the these opposite edges. This allows moving the printer 200 along one dimension, e.g. in the horizontal direction along the surface of the print substrate, as illustrated by the arrow P in FIG. 1. The rollers 48, 50 may secure movement of the printer along a straight line.

In this example, the magnets 50, 52 may be designed and dimensioned to generate a holding force, normal to the print substrate between the first and second platforms 22, 24, which is sufficiently high to securely hold the printer 200 in position and sufficiently low to allow movement of the printer 200 along the print substrate. The normal holding force may be in the range of 20 to 200 N, for example, depending on the thickness of the print substrate and hence the spacing between the magnets. The motor 40, the gearbox 42 and the transmission shafts 44, 46, and the rollers 48, 54 may be designed and dimensioned to hold the printer 200 in position when the motor is not operating and to move the printer 200 in the horizontal direction along the print substrate when the motor is operating. For example, a gear train formed by the gearbox or by the gearbox 42 and the transmission shafts 44, 46 may be a self-locking gear train. The torque transmitted by the motor 40, the gearbox 42, the shafts 44, 46 and the rollers 48, 54 is in the order of around 0.1 Nn.

A printer designed for printing on a non-vertical print substrate may be adjusted in design and dimensions of magnets, motor, gearbox and transmission shafts, for example. Further, the printer also may be designed, alternatively or additionally, for moving the printer in the vertical direction or another non-horizontal direction along the print substrate when the motor is operating. Also in this case, design and dimensions of magnets, motor, gearbox and transmission shafts as well as the orientation of the rollers may be adjusted.

In another example, not illustrated in the drawings, the motor 50, gearbox 42 and transmission shafts 44, 46 may be omitted and the printer 200 may be moved manually along the print substrate in any desired direction.

As illustrated in FIGS. 7 to 10, the front platform 22 and the rear platform 24 may have the same or a similar basic design, including the same or similar outer contour and the same or similar contours for receiving the magnets 50, 52 and the rollers 48, 54. The front platform 22 and the rear platform 24 also may include the same or similar cutouts, such as the cutout 36 for receiving the printhead 26. The front platform 22 and the rear platform 24 also may include the same or similar reinforcement structures, such a honeycomb web structure or another rib structure, not illustrated in the figures. Designing the front platform 22 and the rear platform 24 to have the same or similar general layout allows reducing the number of different parts in manufacturing the printer 200.

During operation of the printer 200 for printing on a print substrate, as illustrated in FIG. 1, movement of the printer 200, i.e. of the front and rear platforms 22, 24, and progress of the printing operation using the printhead 26 is to be synchronized. Synchronization may be implemented by providing a sensor to detect a position and/or movement of the front platform relative to the print substrate. The printhead controller 32 may be coupled to the sensor to control the printing device, including the printhead 26, and the fluid pump 30, for example, in response to the detected movement.

The sensor may be implemented in a number of ways and may include, for example, a wheel running along the surface of the print substrate during movement of the printer 200, the wheel coupled to an encoder disc 90 (FIG. 2), of an optical encoder, for example. In another example, an encoder may be coupled to one or more of the rollers 48 or the printhead rollers 62 which, during operation of the printer 200, run along the surface of the print substrate. For example, the printhead roller 62 may be coupled to the encoder disc 90 by an endless belt (not shown). In these examples, the sensor may be a motion sensor. The sensor, in another example, may include an encoder coupled to the motor 42 to track rotation of the motor. In another example, the sensor may be an optical sensor and may optically scan the surface of the print substrate during movement of the printer 200 to detect the position and/or movement of the printer 200. The sensor may detect a position and/or speed of movement of the printer 200.

FIG. 11 illustrates a flow diagram of a printing method according to an example. The printing method is described with reference to the examples of FIGS. 1 to 10 but also could be implemented with a different printer configuration. At the beginning of a printing operation, at 110, the printer 200 is attached to the print substrate 10 by arranging the front platform 22 and the rear platform 24, which also may be designated as printing platform and counter platform, on opposite sides of the print substrate 10, as shown in FIG. 1. Accordingly, the print substrate 10 is sandwiched between the front platform 22 and rear platform 24, with no direct physical contact between the two platforms. The front platform 22 and the rear platform 24 are coupled and aligned via magnetic forces, e.g. by aligning the magnets 48 of the front platform 22 and the magnets 52 of the rear platform 24, at 112.

A printing operation is started, at 114, by moving the front platform 22 relative to the print subset 10, as schematically illustrated in FIG. 1. Movement of the front platform 22 may be caused by rotation of the motor 40 and transmission of the rotation to the rollers 48 via the gear train formed by the gearbox 42 and the transmission shafts 44, 46In this example, the rear platform 24 will follow movement of the front platform 22 because the rear platform 24 and the front platform 22 are coupled by the magnetic force. Movement of the front platform 22 also may be caused by manually pushing the front platform 22 or the rear platform 24. In one example, movement of the printing platform, at 114, may be in a horizontal direction along the surface of a vertical print substrate 10. Alternatively, movement of the printing platform, at 114, may be in a vertical direction or another non-horizontal along the surface of a vertical print substrate 10.

The position and/or the movement of the front platform 22 relative to the print substrate 10 may be detected, at 116, as described above. Detection of the position and/or movement of the front platform 22 and hence of the printhead 26 is used to synchronize control of the printing process with the movement of the printing device. Accordingly, at 118, an image is printed on the print substrate in response to the detected movement. A print job and/or image data may be stored in a memory of the printing device, e.g. in the memory of the controller 32 associated with the printhead 26.

The preceding description presents and illustrates certain examples. Different sets of features have been described in the examples and these may be applied individually or in combination. The description is not intended to be exhaustive or to limit the described principles to any precise form disclosed. Many modifications and variations are possible in the light of the above teaching. For example, any feature described in relation to any example may be used alone, or in combination, with other features described, and also may be used in combination with any features of any other examples, or any combination of any other examples.

In a variation of the described examples, the printing device may be scalable in that multiple printheads may be supported by the printing platform wherein the printheads may be arranged side-by-side and/or end-to-end to provide a printer capable of applying a spectrum of different printing fluids, e.g. spectrum of different color inks, in a print swath having a desired width. Further, whereas the printer has been described to be movable in the horizontal direction, the printer can be modified to be movable in the vertical direction or to be movable in both horizontal and vertical directions. In a further variation of the described examples, instead of combining the printing platform with a counter platform to be moved together with the printing platform, a static rear surface may be provided, such as a large ferromagnetic surface to be arranged at the rear side of the print substrate. In this example, the static rear surface may be placed adjacent to the rear surface of the print substrate and the printing platform may be arranged at the front surface of the print substrate wherein magnets of the printing platform may interact with the static rear surface.

1. A printer comprising:
a front support supporting a printing device;
the front support to be arranged at a front side of a print substrate and to be aligned relative to a rear support across the print substrate in a contact-less manner.

2. The printer of claim 1, further comprising a magnet arranged on the front support to hold the front support relative to the print substrate and relative to the rear support across the print substrate.

3. The printer of claim 1, wherein the front support comprises a front platform, the front platform supporting a plurality of front magnets and a plurality of rollers/sliders on a front platform surface to be facing the print substrate wherein the rollers/sliders are arranged on a front platform surface to be facing the print substrate to contact the print substrate.

4. The printer of claim 3, wherein the plurality of rollers/sliders extend from the front platform surface at a first height and the plurality of front magnets extend from the front platform surface at a second height, the first height being larger than the second height.

5. The printer of claim 4 wherein the first height is larger than the second height by a delta value which is in the range of 0.5 to 3 mm.

6. The printer of claim 3 wherein the printing device is resiliently supported in the front support to be moveable relative to the front platform surface, in a direction perpendicular to the front platform surface.

7. The printer of claim 3 wherein the plurality of rollers/sliders comprises a driven roller to move the front platform along a surface of the print substrate.

8. The printer of claim 7, further comprising a motor and a gear train supported by the front platform to drive the driven roller.

9. The printer of claim 8 wherein the gear train is a self-locking gear train.

10. The printer of claim 3, further comprising a sensor to detect movement of the front platform relative to the print substrate.

11. The printer of claim 10, further comprising a printing controller coupled to the sensor to control the printing device in response to a detected movement of the front platform.

12. The printer of claim 3, further comprising:
a rear support;
the rear support comprising a rear platform supporting a plurality of rear magnets wherein respective pairs of front and rear magnets are arranged respectively on facing sides of the front and rear platforms to align the front platform and the rear platform relative to each other across the print substrate.

13. A printer, comprising
a printing platform supporting a printhead mount, a plurality of magnets, a plurality of rollers,
an electric motor, a transmission gear, a controller and a motion sensor, the printing platform having a front side and a rear side; wherein
the printhead mount is to receive a printhead to eject printing fluid from the front side of the front support;
the plurality of rollers extend from the front side of the front printing platform;
the plurality of rollers are coupled to the electric motor via the transmission gear;
the motion sensor is to detect movement of the printing platform;
the motion sensor is coupled to the controller; and
the controller is to control a printhead received in the printhead mount in response to the detected movement.

14. The printer of claim 13, further comprising
a counter platform supporting a plurality of counter magnets; wherein
respective pairs of magnets and counter magnets are arranged respectively on facing sides of the printing platform and the counter platform to align the printing platform and the counter platform relative to each other across a print substrate; and
the rollers supported by the printing platform are driven by the electric motor via the transmission gear to position the front platform and the rear platform relative to the print substrate.

15. A method of direct printing on a non-horizontal print substrate, the method comprising:
arranging a printing platform on one side of the print substrate and a counter platform on the opposite side of the print substrate;
coupling the printing platform with the counter platform via magnetic forces;
moving the printing platform relative to the print substrate;
detecting movement of the printing platform relative to the print substrate; and controlling a printing device carried by the printing platform in response to the detected movement.
